(19) United States
(12) Patent Application Publication
(10) Pub. No.: US 2025/0219293 A1
(43) Pub. Date: Jul. 3, 2025

(54) ELECTRONIC DEVICE COMPRISING ANTENNA

(71) Applicant: Samsung Electronics Co., Ltd., Suwon-si (KR)

(72) Inventors: Junghwan YEOM, Suwon-si (KR); Jin KIM, Suwon-si (KR); Jongoh LIM, Suwon-si (KR)

(21) Appl. No.: 19/082,866

(22) Filed: Mar. 18, 2025

Related U.S. Application Data
(63) Continuation of application No. PCT/KR2023/012963, filed on Aug. 31, 2023.

(30) Foreign Application Priority Data
Oct. 5, 2022 (KR) 10-2022-0126825
Dec. 1, 2022 (KR) 10-2022-0166069

(51) Int. Cl. H01Q 7/00; H01Q 1/24; H01Q 1/38; H01Q 5/307

(52) U.S. Cl. CPC H01Q 7/00; H01Q 1/24; H01Q 1/38; H01Q 5/307

(57) ABSTRACT

An electronic device may include a substrate and a wireless communication circuit. The substrate may include a housing, a ground area, a first conductive pattern, a second conductive pattern, and a third conductive pattern. The housing may include a conductive portion. The first conductive pattern is electrically connected to the conductive portion. The second conductive pattern is electrically connected to the ground area. The first conductive pattern electrically connects the conductive portion to the ground area. The wireless communication circuit is configured to supply power to the conductive portion through the first conductive pattern. The second conductive pattern may include a closed loop shape. The second conductive pattern is at least partially located between at least the first conductive pattern and the third conductive pattern.

### CROSS-REFERENCE TO RELATED APPLICATION(S)

This application is a continuation application of International Application No. PCT/KR2023/012963 designating the United States, filed on Aug. 31, 2023, in the Korean Intellectual Property Receiving Office and claiming priority to Korean Patent Application No. 10-2022-0126825, filed on Oct. 5, 2022, and Korean Patent Application No. 10-2022-0166069, filed on Dec. 1, 2022, the disclosures of which are all hereby incorporated by reference herein in their entireties.

### BACKGROUND

### 1. Field

Certain example embodiments may relate to an electronic device including an antenna.

### 2. Description of Related Art

An electronic device may include an antenna for performing wireless communication. As the electronic device is to cover more and more communication bands, a plurality of antennas are included in the electronic device. The antennas may interfere with each other or may interfere with other components of the electronic device, and therefore noise may be generated during the wireless communication. A path along which the noise is induced from an aggressor (or, a noise source) may include, for example, a conductive path, a radiative path, and an electro-magnetic coupling path. However, it is not admitted that the related art described above is prior art.

The above information is presented as background information only to assist with an understanding of the disclosure. No determination has been made, and no assertion is made, as to whether any of the above might be applicable as prior art with regard to the disclosure.

### SUMMARY

In accordance with an example embodiment, an electronic device may include a substrate and a wireless communication circuit. The substrate may include a housing, a ground area, a first conductive pattern, a second conductive pattern, and a third conductive pattern. The housing may include a conductive portion. The first conductive pattern is electrically connected, directly or indirectly, to the conductive portion. The second conductive pattern is electrically connected, directly or indirectly, to the ground area. The first conductive pattern electrically connects, directly or indirectly, the conductive portion to the ground area. The wireless communication circuit is configured to supply power to the conductive portion through the first conductive pattern. The second conductive pattern may include a closed loop shape. The second conductive pattern is at least partially located between the first conductive pattern and the third conductive pattern.

In accordance with another example embodiment, an electronic device may include a housing, a substrate, and a wireless communication circuit. The housing may include a conductive portion. The substrate may include a ground area, a first conductive pattern, a second conductive pattern, and a fourth conductive pattern. The first conductive pattern is electrically connected, directly or indirectly, to the conductive portion. The second conductive pattern is electrically connected, directly or indirectly, to the ground area. The fourth conductive pattern diverges and extends from the first conductive pattern. The wireless communication circuit is configured to supply power to the conductive portion through the first conductive pattern. The second conductive pattern may include a closed loop shape. The fourth conductive pattern may include a loop pattern. The second conductive pattern is at least partially located within the loop pattern of the fourth conductive pattern.

In accordance with another example embodiment, an electronic device may include an antenna structure, a substrate, and a wireless communication circuit disposed on, directly or indirectly, the substrate. The antenna structure may include a radiating arm, a feed line, a shorting line, and a decoupling pattern. The feed line at least partially may include a conductive pattern of the substrate and is electrically connected, directly or indirectly, between at least the wireless communication circuit and the radiating arm. The shorting line at least partially may include a conductive pattern of the substrate and grounds the radiating arm. The decoupling pattern may include a conductive pattern of the substrate. The decoupling pattern may include a closed loop shape. The decoupling pattern is at least partially located between the feed line and the shorting line.

### BRIEF DESCRIPTION OF THE DRAWINGS

FIG. 1 is a view illustrating a flat state of an electronic device according to an example embodiment;

FIG. 2 is a view illustrating a folded state of the electronic device according to an example embodiment;

FIG. 3A is an exploded perspective view of the electronic device according to an example embodiment;

FIG. 3B is an exploded perspective view of the electronic device according to an example embodiment;

FIG. 4A is a plan view illustrating the electronic device according to an example embodiment;

FIG. 4B is a view illustrating area R of FIG. 4A;

FIG. 5A is a graph depicting isolation between antennas according to a comparative example;

FIG. 5B is a graph depicting noise of an antenna according to the comparative example;

FIG. 5C is a view illustrating a current intensity distribution of an electronic device in a wireless communication situation according to the comparative example;

FIG. 6A is a view illustrating an antenna structure according to an example embodiment;

FIG. 6B is a view illustrating the antenna structure according to an example embodiment;

FIG. 7A is a view illustrating a noise current flow of the antenna structure according to an example embodiment;

FIG. 7B is a view illustrating the noise current flow and intensity of the antenna structure according to an example embodiment;

FIG. 8 is a view illustrating an antenna structure according to an example embodiment;

FIG. 9A is a view illustrating an antenna structure according to an example embodiment;

FIG. 9B is a view illustrating the antenna structure according to an example embodiment;

FIG. 10 is a view illustrating an antenna structure according to an example embodiment; and

FIG. 11 is a graph depicting radiation efficiencies of example antennas.

FIG. 12 is a block diagram illustrating an electronic device 1201 in a network environment 1200 according to various example embodiments.

In the following description made with respect to the accompanying drawings, identical or similar components will be assigned with identical or similar reference numerals.

### DETAILED DESCRIPTION

Hereinafter, various embodiments of the disclosure will be described with reference to accompanying drawings. Accordingly, those of ordinary skill in the art will recognize that modification, equivalent, and/or alternative on the various embodiments described herein can be variously made without departing from the scope and spirit of the disclosure. In addition, repetitive descriptions of components having identical reference numerals in the disclosure will be omitted.

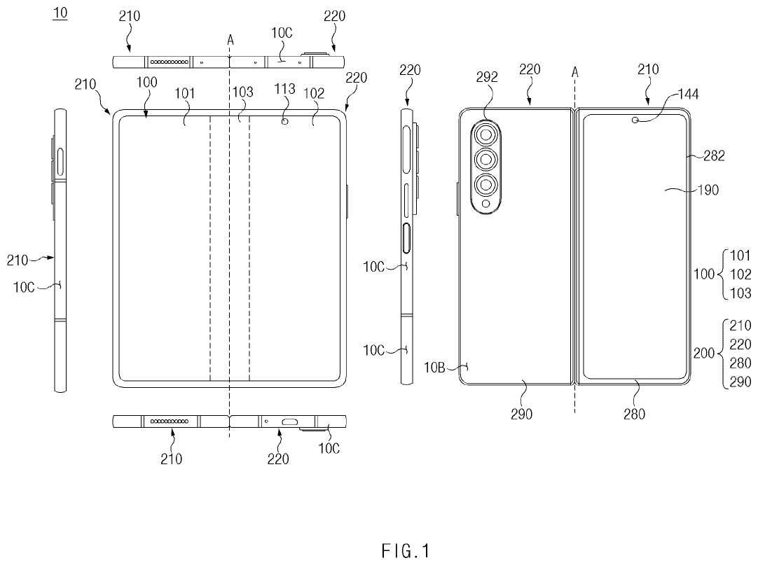

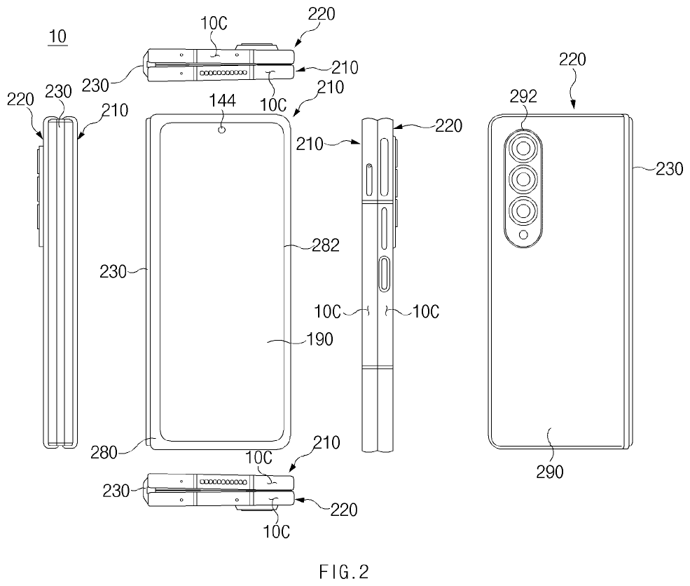

FIG. 1 is a view illustrating a flat state of an electronic device according to an embodiment. FIG. 2 is a view illustrating a folded state of the electronic device according to an embodiment.

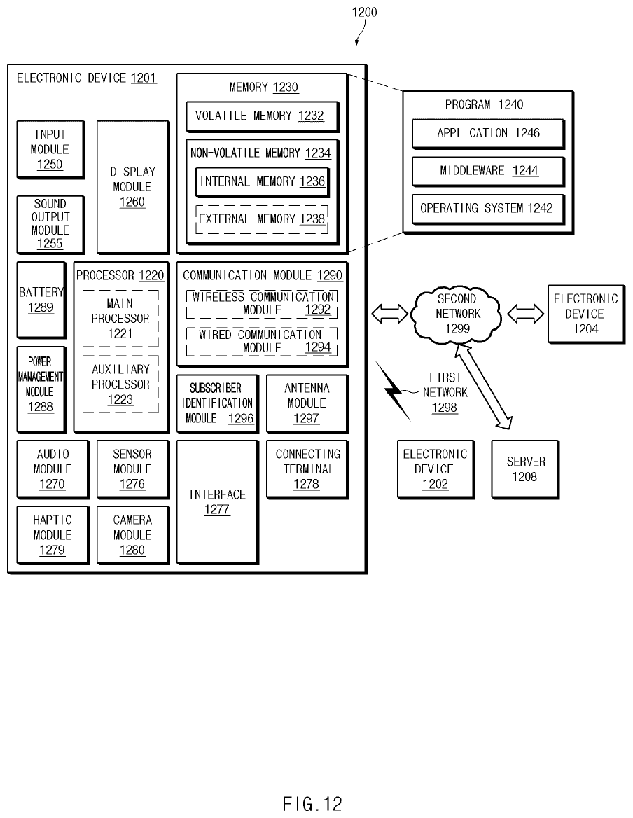

Referring to FIGS. 1 and 2, in an embodiment, the electronic device 10 (e.g., an electronic device 1201 of FIG. 12) may include a foldable housing 200 (hereinafter, referred to as the housing 200), a hinge cover 230 that covers a foldable portion of the housing 200, and a flexible or foldable display 100 (hereinafter, referred to as the display 100) that is disposed in a space formed by the housing 200.

In an embodiment, the electronic device 10 may be a foldable electronic device that is deformable to a flat state (e.g., the state of FIG. 1, unfolded state) and a folded state (e.g., the state of FIG. 2). For example, a first housing structure 210 and a second housing structure 220 of the electronic device 10 may be coupled so as to be rotatable relative to each other.

In this disclosure, a surface on which the display 100 is disposed is defined as a first surface 10A or a front surface 10A of the electronic device 10. A surface opposite the front surface 10A is defined as a second surface 10B or a rear surface 10B of the electronic device 10. A surface surrounding a space between the front surface 10A and the rear surface 10B is defined as a third surface 10C or a side surface 10C of the electronic device 10.

In an embodiment, the housing 200 may include the first housing structure 210, the second housing structure 220, a first back cover 280, and a second back cover 290. The housing 200 of the electronic device 10 is not limited to the form and coupling illustrated in FIGS. 1 and 2 and may be implemented by a combination and/or coupling of other shapes or components. For example, the first housing structure 210 and the first back cover 280 may be integrally formed with each other, and the second housing structure 220 and the second back cover 290 may be integrally formed with each other.

In the illustrated embodiment, the first housing structure 210 and the second housing structure 220 may be disposed on opposite sides with respect to a folding axis (an axis A) and may have shapes substantially symmetrical to each other with respect to the folding axis A. As will be described below, the angle or distance between the first housing structure 210 and the second housing structure 220 may vary depending on whether the electronic device 10 is in a flat state, a folded state, or an intermediate state.

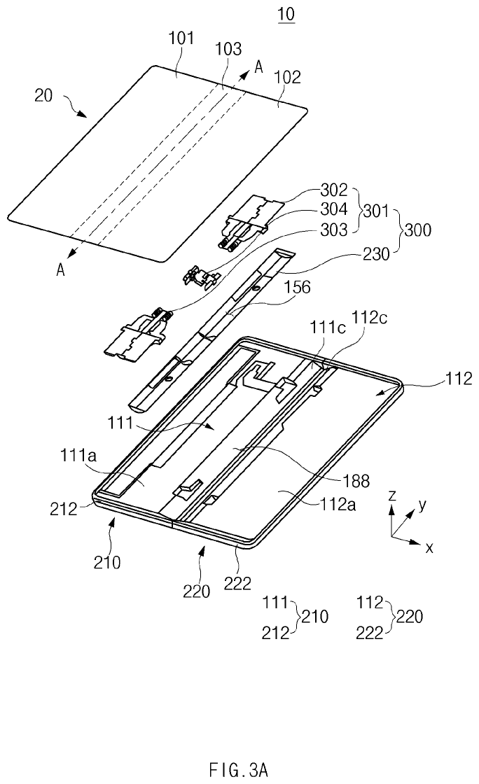

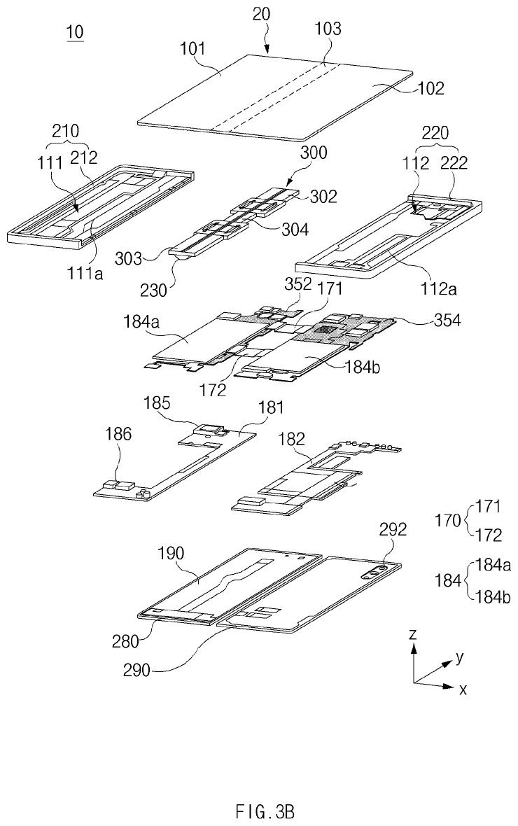

In an embodiment, the first housing structure 210 may rotate relative to the second housing structure 220 through a hinge structure (e.g., a hinge member 300 of FIG. 3). The electronic device 10 may operate in an in-folding manner and/or an out-folding manner as the first housing structure 210 rotates relative to the second housing structure 220. Here, the in-folding manner may be a manner in which the front surface 10A of the display 100 is folded in opposite directions toward each other, and the out-folding manner may be a manner in which the front surface 10A of the display 100 is folded in opposite directions away from each other. Although FIG. 2 illustrates a state in which the electronic device 10 is folded in the in-folding manner, the electronic device 10 is not limited by the illustrated example.

In an embodiment, the first housing structure 210 and the second housing structure 220 may together form a recess that accommodate the display 100.

In an embodiment, at least a portion of the first housing structure 210 and at least a portion of the second housing structure 220 may be formed of a metallic or non-metallic material having a selected magnitude of rigidity to support the display 100.

In an embodiment, the first back cover 280 may be disposed on, directly or indirectly, the rear surface 10B of the electronic device 10 so as to be located on one side of the folding axis A. The first back cover 280 may have, for example, a substantially rectangular periphery. The periphery of the first back cover 280 may be surrounded by the first housing structure 210. Similarly, the second back cover 290 may be disposed on the rear surface 10B of the electronic device 10 so as to be located on an opposite side of the folding axis A, and the periphery of the second back cover 290 may be surrounded by the second housing structure 220. In an embodiment, the first back cover 280 and the second back cover 290 may constitute most of the rear surface 10B of the electronic device 10. For example, the rear surface 10B of the electronic device 10 may include the first back cover 280, a partial area of the first housing structure 210 adjacent to the first back cover 280, the second back cover 290, and a partial area of the second housing structure 220 adjacent to the second back cover 290.

In the illustrated embodiment, the first back cover 280 and the second back cover 290 may have substantially symmetrical shapes with respect to the folding axis (the axis A). However, the first back cover 280 and the second back cover 290 do not necessarily have mutually symmetrical shapes. For example, the electronic device 10 may include the first back cover 280 and the second back cover 290 that have various shapes. For example, the first back cover 280 may be integrally formed with the first housing structure 210. For example, the second back cover 290 may be integrally formed with the second housing structure 220.

In an embodiment, the first back cover 280, the second back cover 290, the first housing structure 210, and the second housing structure 220 may form a space in which various components of the electronic device 10 are disposed. In an embodiment, one or more components may be disposed, or visually exposed, on the rear surface 10B of the electronic device 10. For example, at least a portion of a sub-display 190 may be visually exposed through a first rear area 282 of the first back cover 280. In an embodiment, one or more components or sensors may be visually exposed through a second rear area 292 of the second back cover 290. In various embodiments, the sensors may include a proximity sensor and/or a rear camera.

In an embodiment, the hinge cover 230 may be disposed between the first housing structure 210 and the second housing structure 220. The hinge cover 230 may be configured to hide an internal component (e.g., the hinge structure).

In an embodiment, depending on a state (a flat state or a folded state) of the electronic device 10, the hinge cover 230 may be at least partially hidden by a portion of the first housing structure 210 and a portion of the second housing structure 220 or may be at least partially exposed to the outside. For example, when the electronic device 10 is in a flat state as illustrated in FIG. 1, the hinge cover 230 may be hidden by the first housing structure 210 and the second housing structure 220 and may not be exposed. For example, when the electronic device 10 is in a folded state (e.g., a fully folded state) as illustrated in FIG. 2, the hinge cover 230 may be exposed to the outside from between the first housing structure 210 and the second housing structure 220. For example, when the electronic device 10 is in an intermediate state in which the first housing structure 210 and the second housing structure 220 are folded with a certain angle, the hinge cover 230 may be partially exposed to the outside from between the first housing structure 210 and the second housing structure 220. However, in this case, the exposed area may be smaller than that in the fully folded state. In an embodiment, the hinge cover 230 may include a curved surface, but is not limited thereto.

In an embodiment, the display 100 may be disposed at the top of the space formed by the housing 200. For example, the display 100 may be seated at the top of the recess formed by the housing 200. In an embodiment, the display 100 may constitute most of the front surface 10A of the electronic device 10. For example, the front surface 10A of the electronic device 10 may include the display 100, and a partial area of the first housing structure 210 and a partial area of the second housing structure 220 that are adjacent to the display 100.

The display 100 may include a display, at least a partial area of which is deformable to be flat or curved. In an embodiment, the display 100 may include a folding area 103, a first area 101 disposed on one side with respect to the folding area 103 (on the left side of the folding area 103 illustrated in FIG. 1), and a second area 102 disposed on an opposite side with respect to the folding area 103 (on the right side of the folding area 13 illustrated in FIG. 1).

The division of the display 100 into the areas illustrated in FIG. 1 is illustrative, and the display 100 may be divided differently from the illustrated example depending on the structure or function. For example, in the embodiment illustrated in FIG. 1, the areas of the display 100 may be divided from each other by the folding area 103 or the folding axis (the axis A) that extends parallel to the y-axis. However, unlike that illustrated in FIG. 1, the display 100 may be divided into areas with respect to another folding area (e.g., a folding area parallel to the x-axis) or another folding axis (e.g., a folding axis parallel to the x-axis).

The first area 101 and the second area 102 may have shapes substantially symmetrical to each other with respect to the folding 103, but are not limited thereto.

A camera area 113 may be provided in the first housing structure 210. For example, the camera area 113 may be located on a partial area of the display 100 or may overlap a partial area of the display 100. Alternatively or additionally, the camera area 113 may be disposed in the second housing structure 220. A camera (not illustrated) may be provided in the camera area 113. The camera may be visually exposed through the camera area 113. In an embodiment, the camera exposed through the camera area 113 may include a punch hole camera disposed in a hole or recess formed in the display 100. In an embodiment, the camera may be disposed under the display 100 (e.g., an under display camera (UDC)) so as not to be exposed to the outside of the electronic device 10.

Hereinafter, operations of the first housing structure 210 and the second housing structure 220 and the areas of the display 100 depending on a state (e.g., a flat state or a folded state) of the electronic device 10 will be described.

In an embodiment, when the electronic device 10 is in a flat state (e.g., FIG. 1), the first housing structure 210 and the second housing structure 220 may be disposed to face in the same direction while forming a specified angle (e.g., 180 degrees). A surface of the first area 101 and a surface of the second area 102 of the display 100 may face in the same direction (e.g., in the direction toward the front surface 10A of the electronic device 10) while forming a specified angle (e.g., 180 degrees). The folding area 103 may form the same plane with the first area 101 and the second area 102. For example, the folding area 103 may form a substantially flat surface together with the first area 101 and the second area 102.

In an embodiment, when the electronic device 10 is in a folded state (e.g., FIG. 2), the first housing structure 210 and the second housing structure 220 may be disposed to face each other. The surface of the first area 101 and the surface of the second area 102 of the display 100 may face each other while forming a narrow angle (e.g., an angle between 0 degrees and 10 degrees). At least a portion of the folding area 103 may be curved to have a certain curvature.

In an embodiment, when the electronic device 10 is in an intermediate state, the first housing structure 210 and the second housing structure 220 may be disposed at a certain angle. The surface of the first area 101 and the surface of the second area 102 of the display 100 may form an angle greater than that in the folded state and smaller than that in the flat state. At least a portion of the folding area 103 may be curved to have a certain curvature, and at this time, the curvature may be smaller than that in the folded state.

FIG. 3A is an exploded perspective view of the electronic device according to an embodiment. FIG. 3B is an exploded perspective view of the electronic device according to an embodiment.

Referring to FIGS. 3A and 3B, the electronic device 10 according to an embodiment may include a display 20 (e.g., the display 100 of FIG. 1), the hinge member 300, a first substrate 352, a second substrate 354, a connecting member 170, a first support member 181, a second support member 182, and a battery 184. Some of the components of the electronic device 10 illustrated in FIGS. 3A and 3B may be identical or similar to the components of the electronic device 10 described with reference to FIGS. 1 and 2, and repetitive descriptions will hereinafter be omitted.

The first housing structure 210 may include a first plate 111 (e.g., a first plate structure) and a first side member 212 (e.g., a first side frame structure or a first side bezel structure). The first side member 212 may surround a portion of the periphery of the first plate 111. For example, the first side member 212 may surround the rest other than a portion of the periphery of the first plate 111 that faces toward the second housing structure 220 (e.g., an edge portion facing in the +x-axis direction). The first plate 111 may define a first surface 111a. For example, the first surface 111a may face in the +z-axis direction. At least a portion of the display 20 may be disposed on the first surface 111a. For example, a first area 101 of the display 20 may be disposed on the first surface 111a of the first plate 111. The first plate 111 may be connected with the first side member 212 or may be integrally formed with the first side member 212.

The second housing structure 220 may include a second plate 112 (e.g., a second plate structure) and a second side member 222 (e.g., a second side frame structure or a second side bezel structure). The second side member 222 may surround a portion of the periphery of the second plate 112. For example, the second side member 222 may surround the rest other than a portion of the periphery of the second plate 112 that faces toward the first housing structure 210 (e.g., an edge portion facing in the −x-axis direction). The second plate 112 may define a second surface 112a. For example, the second surface 112a may face in the +z-axis direction. At least a portion of the display 20 may be disposed on the second surface 112a. For example, a second area 102 of the display 20 may be disposed on the second surface 112a of the second plate 112. The second plate 112 may be connected, directly or indirectly, with the second side member 222 or may be integrally formed with the second side member 222.

In an embodiment, a hinge groove 188 may be formed between the first plate 111 and the second plate 112 such that at least a portion of the hinge cover 230 is disposed in the hinge groove 188. The hinge groove 188 may be formed such that at least a portion thereof has a certain curvature in correspondence to the shape of the hinge cover 230. When the electronic device 10 is in a flat state (e.g., the state of FIG. 1), a first support surface 111c of the first plate 111 and a second support surface 112c of the second plate 112 may form the hinge groove 188 to cover the hinge cover 230, thereby hiding the hinge cover 230. When the electronic device 10 is changed from the flat state to a folded state, the first support surface 111c and the second support surface 112c may move to positions facing each other along the curved surface of the hinge cover 230 and may expose the hinge cover 230 to the outside of the electronic device 10.

The display 20 may be disposed on, directly or indirectly, the first plate 111 of the first housing structure 210 and the second plate 112 of the second housing structure 220. The display 20 may be partially supported, directly or indirectly, by the first surface 111a of the first plate 111 and the second surface 112a of the second plate 112. The display 20 may include the first area 101 disposed on the first plate 111, the second area 102 disposed on the second plate 112, and a folding area 103 located between the first area 101 and the second area 102. For example, at least a portion of the first area 101 may be attached to the first surface 111a of the first plate 111, and at least a portion of the second area 102 may be attached to the second surface 112a of the second plate 112.

The first back cover 280 may be disposed to face the first plate 111. The second back cover 290 may be disposed to face the second plate 112. For example, the first back cover 280 may be disposed under the first plate 111 (e.g., in the −z-axis direction), and the second back cover 290 may be disposed under the second plate 112 (e.g., in the −z-axis direction).

The first back cover 280 may be coupled to the first housing structure 210 to form, between the first back cover 280 and the first plate 111, a space in which other components (e.g., the first substrate 352, a first battery 184a, and speaker modules 185 and 186) are accommodated. The second back cover 290 may be coupled to the second housing structure 220 to form, between the second back cover 290 and the second plate 112, a space in which other components (e.g., the second substrate 354 and a second battery 184b) are accommodated.

The sub-display 190 may be disposed on, directly or indirectly, one surface of the first back cover 280. The second rear area 292 may be formed on the second back cover 290. For example, the second rear area 292 may be formed by a camera decoration member (or, a camera deco) or may be provided in the form of the camera decoration member.

The hinge member 300 may include hinge structures (or, hinge modules) 301 and the hinge cover 230. The hinge cover 230 may include an inner space 156 in which at least portions of the hinge structures 301 are accommodated. The hinge structures 301 may include a first hinge structure 302, a second hinge structure 303, and a third hinge structure 304 arranged in a direction parallel to the folding axis A. For example, the first hinge structure 302 may be disposed adjacent to the edges of the first housing structure 210 and the second housing structure 220 that face in the +y-axis direction. The second hinge structure 303 may be disposed adjacent to the edges of the first housing structure 210 and the second housing structure 220 that face in the-y-axis direction. The third hinge structure 304 may be disposed between the first hinge structure 302 and the second hinge structure 303. However, the illustrated embodiment is illustrative, and according to various embodiments, the third hinge structure 304 may be omitted.

The hinge structures 301 may rotatably connect, directly or indirectly, the first housing structure 210 and the second housing structure 220. The hinge structures 301 may be disposed between the first housing structure 210 and the second housing structure 220 and may be coupled to the first housing structure 210 and the second housing structure 220. For example, each of the hinge structures 301 may be configured such that one portion is coupled to the hinge cover 230 and other portions are coupled to the first housing structure 210 and the second housing structure 220. The first housing structure 210 and the second housing structure 220 may rotate about rotational axes formed by the hinge structures 301.

The first substrate 352 may be disposed in the first housing structure 210. The second substrate 354 may be disposed in the second housing structure 220. The first substrate 352 and the second substrate 354 may be electrically connected through the connecting member 170. The first substrate 352 and the second substrate 354 may include, for example, a printed circuit board.

The first substrate 352 may be accommodated in the space between the first plate 111 and the first back cover 280. The first substrate 352 may be disposed under the first plate 111 (e.g., in the −z-axis direction) and may face a portion of the first plate 111. For example, the first substrate 352 may be disposed between the first plate 111 and the first support member 181. The first substrate 352 may be supported, directly or indirectly, by the first plate 111.

The second substrate 354 may be accommodated in the space between the second plate 112 and the second back cover 290. The second substrate 354 may be disposed under the second plate 112 (e.g., in the −z-axis direction) and may face a portion of the second plate 112. For example, the second substrate 354 may be disposed between the second plate 112 and the second support member 182. The second substrate 354 may be supported, directly or indirectly, by the second plate 112.

A processor, a memory, and/or an interface may be disposed on the first substrate 352 and/or the second substrate 354. For example, the processor may include one or more of a central processing unit, an application processor, a graphic processing unit, an image signal processor, a sensor hub processor, or a communication processor. For example, the memory may include a volatile memory or a non-volatile memory. For example, the interface may include a high definition multimedia interface (HDMI), a universal serial bus (USB) interface, an SD card interface, and/or an audio interface. The interface may electrically or physically connect the electronic device 10 with an external electronic device and may include a USB connector, an SD card/MMC connector, or an audio connector.

The connecting member 170 may electrically connect, directly or indirectly, the first substrate 352 and the second substrate 354. One end portion of the connecting member 170 may be connected to the first substrate 352, and an opposite end portion of the connecting member 170 may be connected to the second substrate 354. For example, connectors may be formed on the opposite end portions of the connecting member 170. The connecting member 170 may extend in a direction substantially perpendicular to the folding axis A and may cross the first housing structure 210, the hinge cover 230, and the second housing structure 220. For example, the central portion of the connecting member 170 may extend across the hinge cover 230 so that the opposite end portions of the connecting member 170 may be connected to the first substrate 352 and the second substrate 354. The connecting member 170 may be formed of a flexible conductive material and may be moved or deformed in response to folding and unfolding operations of the electronic device 10. For example, the connecting member 170 may include a flexible printed circuit board.

The connecting member 170 may include a first connecting member 171 and a second connecting member 172. The first connecting member 171 and the second connecting member 172 may be connected, directly or indirectly, to different areas of the first substrate 352 and the second substrate 354. Between the first hinge structure 302 and the third hinge structure 304, the first connecting member 171 may extend across the hinge cover 230. For example, in the inner space 156 of the hinge cover 230, a portion of the first connecting member 171 may be located or accommodated in the space between the first hinge structure 302 and the third hinge structure 304. Between the second hinge structure 303 and the third hinge structure 304, the second connecting member 172 may extend across the hinge cover 230. For example, in the inner space 156 of the hinge cover 230, a portion of the second connecting member 172 may be located or accommodated in the space between the second hinge structure 303 and the third hinge structure 304.

The first support member 181 may be disposed in the first housing structure 210. For example, the first support member 181 may be disposed between the first substrate 352 and the first back cover 280. For example, the first support member 181 may be disposed between the first substrate 352 and the sub-display 190. The second support member 182 may be disposed in the second housing structure 220. For example, the second support member 182 may be disposed between the first substrate 354 and the second back cover 290.

The speaker modules 185 and 186 may be disposed on the first support member 181. For example, the first speaker module 185 (e.g., an upper speaker module) may be disposed on an upper end portion (e.g., the +y-axis direction) of the first support member 181, and the second speaker module 186 (e.g., a lower speaker module) may be disposed on a lower end portion (e.g., the −y-axis direction) of the first support member 181. One or more antennas may be disposed or formed on the second support member 182.

The battery 184 may be a device for supplying power to at least one component of the electronic device 10. The battery 184 may include, for example, a secondary cell that is rechargeable or a fuel cell. The battery 184 may include the first battery 184a disposed in the first housing structure 210 and the second battery 184b disposed in the second housing structure 220. The first battery 184a may be coupled to the first substrate 352, and the second battery 184b may be coupled to the second substrate 354.

An example of the foldable electronic device 10 has been described with reference to FIGS. 1, 2, 3A, and 3B. However, the electronic device 10 according to various embodiments of the disclosure is not limited by the above-described example. The electronic device 10 may include various electronic devices. For example, the electronic device 10 according to various embodiments of the disclosure may include a bar-type electronic device, a rollable electronic device, a slidable electronic device, a wearable electronic device, a tablet personal computer (PC), and/or a notebook PC (or, a laptop PC).

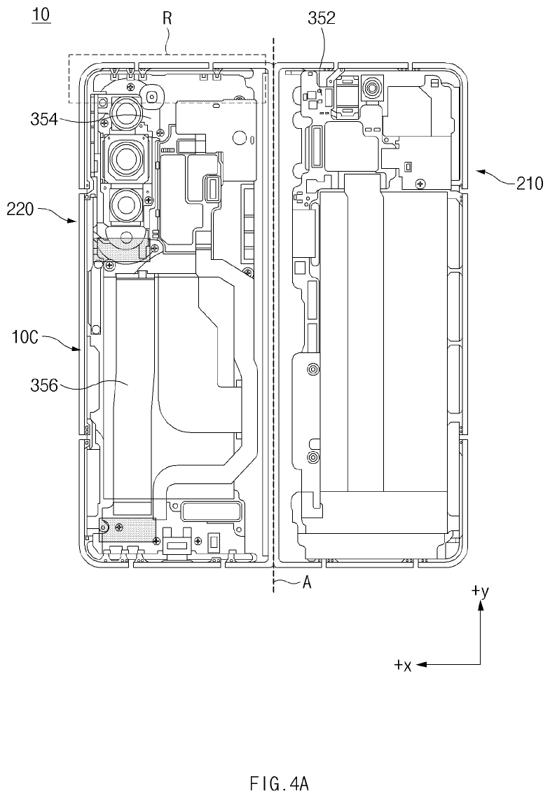

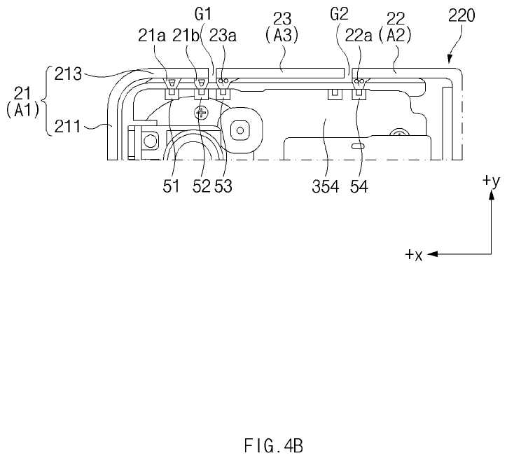

FIG. 4A is a plan view illustrating the electronic device according to an embodiment. FIG. 4A may be a view in which the first back cover 280 and the second back cover 290 of the electronic device 10 illustrated in FIG. 1 are omitted. FIG. 4B is a view illustrating area R of FIG. 4A.

Referring to FIG. 4A, the electronic device 10 according to an embodiment may include the second substrate 354 disposed in the second housing structure 220. The second substrate 354 may include at least one printed circuit board. When the second substrate 354 includes a plurality of printed circuit boards, the plurality of printed circuit boards may be electrically connected with each other through at least a connecting member 356 (e.g., a flexible printed circuit board).

In an embodiment, the first housing structure 210 and the second housing structure 220 may at least partially define the exterior of the electronic device 10. For example, the first housing structure 210 and the second housing structure 220 may at least partially form the side surface 10C of the electronic device 10.

In an embodiment, the second housing structure 220 may include a conductive portion that at least partially forms the side surface 10C of the electronic device 10. The conductive portion may be constituted by a plurality of segments. For example, referring to FIG. 4B together with FIG. 4A, the second housing structure 220 may include a first portion 21, a second portion 22, and a third portion 23 that include an electrically conductive material (e.g., metal).

In an embodiment, the first portion 21 may include a first sub-portion 211 and a second sub-portion 213 extending from the first sub-portion 211. The first sub-portion 211 may extend in a first direction (e.g., the y-axis direction). The first direction may be, for example, a direction substantially parallel to the folding axis A defined between the first housing structure 210 and the second housing structure 220, but is not limited thereto. The second sub-portion 213 may extend from the first sub-portion 211 toward the folding axis A or the first housing structure 210. The second sub-portion 213 may extend from the first sub-portion 211 in a second direction (e.g., the x-axis direction) different from the first direction. The second direction may be, for example, a direction substantially perpendicular to the first direction, but is not limited thereto.

In an embodiment, the second portion 22 may extend in substantially the same direction as the second sub-portion 213 of the first portion 21. For example, the second portion 22 may extend in the second direction (e.g., the x-axis direction), but is not limited thereto. The second portion 22 may be spaced apart from the first portion 21 and the third portion 23.

In an embodiment, the third portion 23 may be located between the first portion 21 and the second portion 22. The third portion 23 may extend in substantially the same direction as the second sub-portion 213 of the first portion 21 and the second portion 22. For example, the third portion 23 may extend in the second direction (e.g., the x-axis direction), but is not limited thereto.

In an embodiment, the third portion 23 may be spaced apart from the second sub-portion 213 of the first portion 21. For example, the third portion 23 may be spaced apart from an end of the second sub-portion 213 that faces in the second direction. As the first portion 21 and the third portion 23 are spaced apart from each other, a first gap G1 may be defined. In an embodiment, the second portion 22 may be spaced apart from the third portion 23. For example, the second portion 22 may be spaced apart from an end of the third portion 23 that faces in the second direction. As the second portion 22 and the third portion 23 are spaced apart from each other, a second gap G2 may be defined. For example, an insulating material, such as a non-conductive resin, may be at least partially disposed in the first gap G1 and the second gap G2. The insulating material (or, the non-conductive material) that fills the first gap G1 and the second gap G2 may define the side surface 10C of the electronic device 10 together with the conductive portion of the second housing structure 220.

The electronic device 10 according to an embodiment may include a connecting member for electrically connecting, directly or indirectly, the conductive portion of the second housing structure 220 to the second substrate 354. For example, the electronic device 10 may include a first connecting member 51, a second connecting member 52, a third connecting member 53, and a fourth connecting member 54. The first connecting member 51 and the second connecting member 52 may electrically connect the first portion 21 of the second housing structure 220 to the second substrate 354. The third connecting member 53 may electrically connect the third portion 23 of the second housing structure 220 to the second substrate 354. The fourth connecting member 54 may electrically connect the second portion 22 of the second housing structure 220 to the second substrate 354. The first connecting member 51, the second connecting member 52, the third connecting member 53, and the fourth connecting member 54 may be disposed on the second substrate 354.

The electronic device 10 according to an embodiment may include a first wireless communication circuit (not illustrated) (e.g., a wireless communication module 1292 of FIG. 12) disposed on the second substrate 354. The first wireless communication circuit may be electrically connected with the connecting members through a conductive trace (or, a conductive pattern) provided by the second substrate 354. In addition, the first wireless communication circuit may be electrically connected to the conductive portion of the second housing structure 220 through the connecting members. For example, the first wireless communication circuit may be electrically connected to the first portion 21 of the second housing structure 220 through the first connecting member 51 and/or the second connecting member 52. For example, the first wireless communication circuit may be electrically connected to the third portion 23 of the second housing structure 220 through the third connecting member 53. For example, the first wireless communication circuit may be electrically connected to the second portion 22 of the second housing structure 220 through the fourth connecting member 54. The first connecting member 51, the second connecting member 52, the third connecting member 53, and the fourth connecting member 54 may include, for example, a contact member (e.g., a C-clip or a side-clip), a connector, or a coaxial cable that is formed of a conductive material, but are not limited thereto.

In an embodiment, the conductive portion of the second housing structure 220 electrically connected, directly or indirectly, with the first wireless communication circuit may form at least one antenna for performing wireless communication. For example, the first portion 21 of the second housing structure 220 may at least partially form a first antenna A1 that receives power through the first connecting member 51 and/or the second connecting member 52. When the first portion 21 receives power through the first connecting member 51 or the second connecting member 52, the second connecting member 52 or the first connecting member 51 may be electrically connected to a conductive area of the second substrate 354 that provides a ground for the first antenna A1. For example, the second portion 22 of the second housing structure 220 may at least partially form a second antenna A2 that receives power through the fourth connecting member 54. For example, the third portion 23 of the second housing structure 220 may at least partially form a third antenna A3 that receives power through the third connecting member 53. However, the positions and/or number of connecting members for electrically connecting the conductive portion of the second housing structure 220 are not limited by the illustrated example. For example, depending on the required communication performance of the antennas of the electronic device 10, the positions and/or number of connecting members may be different from the illustrated example. For example, the position of the third connecting member 53 may vary depending on the required characteristics (e.g., the resonant frequency) of the third antenna A3 corresponding to the third portion 23. For example, when the third connecting member 53 constitutes a feed line of the third antenna A3 corresponding to the third portion 23, a connecting member that electrically connects the third portion 23 to the conductive area (e.g., a ground plane) of the second substrate 354 may be further disposed to constitute a shorting line of the third antenna A3. For example, a connecting member that constitutes an additional feed line and/or an additional shorting line may be further disposed such that the third antenna A3 corresponding to the third portion 23 forms a multi-band resonance frequency.

In an embodiment, the first wireless communication circuit may transmit and/or receive a wireless signal using at least one of the first antenna A1, the second antenna A2, and/or the third antenna A3. The first antenna A1, the second antenna A2, and the third antenna A3 may be configured to transmit and receive wireless signals corresponding to various frequency bands (e.g., LTE, Bluetooth, Wi-Fi, GPS, UWB, and the like), but are not limited thereto.

The description of the second housing structure 220 may be applied to the first housing structure 210 in a substantially identical, similar, or corresponding manner. For example, the first housing structure 210 may include a conductive portion that at least partially forms the side surface 10C of the electronic device 10. The conductive portion may be constituted by a plurality of segments. The conductive portion of the first housing structure 210 may be electrically connected, directly or indirectly, to the first substrate 352 disposed in the first housing structure 210. In addition, through a connecting member (e.g., a connection member 170 of FIG. 3) that electrically connects, directly or indirectly, the first substrate 352 and the second substrate 354, the conductive portion of the first housing structure 210 may be electrically connected to the first wireless communication circuit or may be electrically connected with a second wireless communication circuit (e.g., the wireless communication module 1292 of FIG. 12) disposed on the first substrate 352. Accordingly, the conductive portion of the first housing structure 210 may form at least one antenna for performing wireless communication.

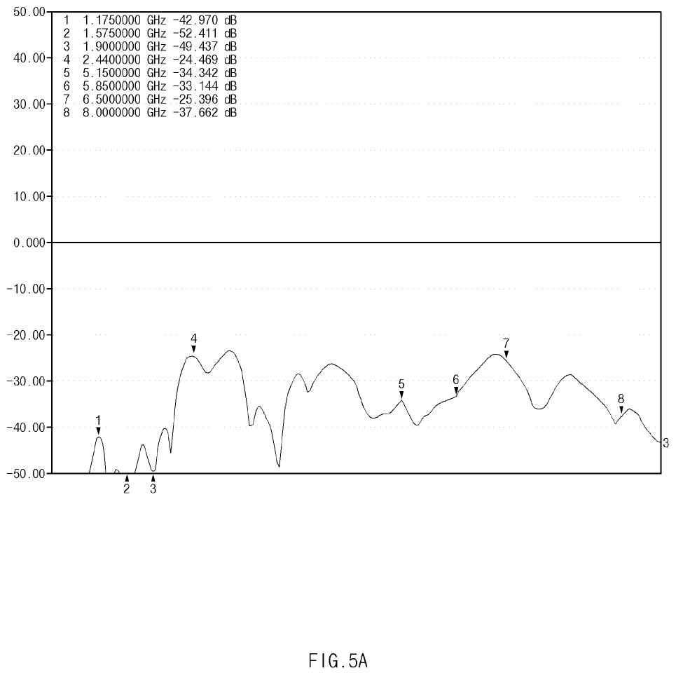

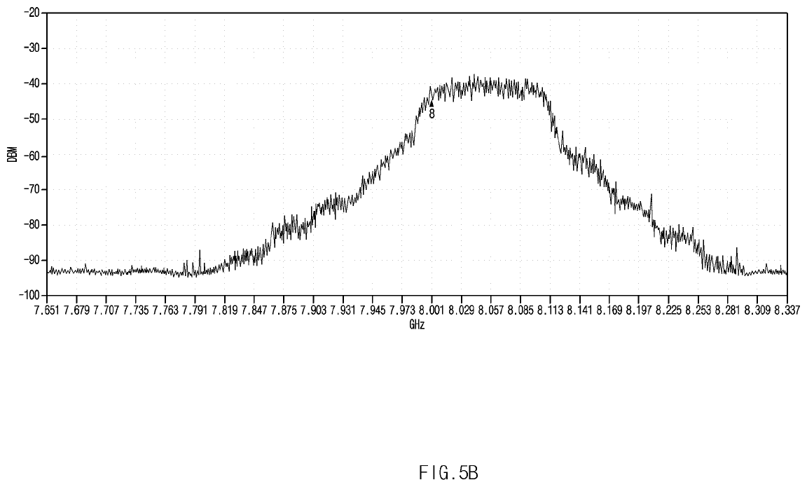

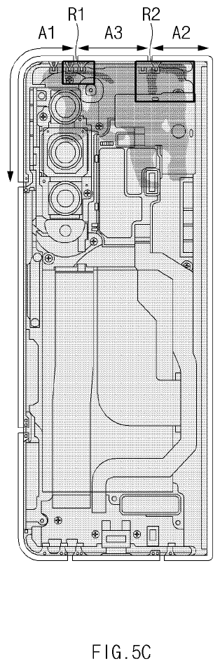

FIG. 5A is a graph depicting isolation between antennas according to a comparative example. FIG. 5A is a graph depicting isolation (an S parameter) between a second antenna (e.g., the second antenna A2 of FIG. 4B) and a third antenna (e.g., the third antenna A3 of FIG. 4B) in the comparative example. Referring to FIG. 5A, in a target frequency band 8, the isolation between the second antenna and the third antenna adjacent to each other may be about −35 dB or less. This may mean that the influence of radiation of the second antenna on noise induced in the third antenna or a radio frequency (RF) receiver electrically connected to the third antenna is not significant. For example, this may mean that the influence of a radiative path among the paths of noise induced in the third antenna or the RF receiver due to the second antenna is not significant.

FIG. 5B is a graph depicting noise of an antenna according to the comparative example. FIG. 5B is a graph depicting a noise level induced in the third antenna (e.g., the third antenna A3 of FIG. 4B) or the RF receiver (e.g., the first wireless communication circuit) connected to the third antenna in the comparative example. Referring to FIG. 5B, in the comparative example, the noise induced in the third antenna or the RF receiver connected to the third antenna may be about −40 dBM in the target frequency band 8 and may be higher than those in other frequency bands. This may mean that an electro-magnetic field generated by a noise current of an antenna adjacent to the third antenna, such as the second antenna (e.g., the second antenna A2 of FIG. 4B), is coupled to the third antenna and induced in the RF receiver connected to the third antenna. For example, this may mean that the influence of an electro-magnetic coupling path among the paths of the noise induced in the third antenna or the RF receiver due to the second antenna is greater than the influence of the radiative path described with reference to FIG. 5A.

A shielding member may be disposed around a noise source or an aggressor (e.g., the second antenna) to reduce noise, but this may result in cost and space losses. In addition, the noise source and a victim (e.g., the RF receiver connected to the third antenna) may be disposed away from each other to reduce noise, but this may have spatial loss and design constraints and may affect communication performance as a transmission line is elongated. Because a portable communication device such as electronic devices 10 has a limited volume, antennas for supporting wireless communication in various bands have to be disposed adjacent to each other, and therefore problems caused by noise between the antennas may become more severe.

FIG. 5C is a view illustrating a current intensity distribution of an electronic device in a wireless communication situation according to the comparative example. In FIG. 5C, the relatively dark shaded area may be an area where a relatively strong current flows. Referring to FIG. 5C, the electronic device according to the comparative example may include an area R1 corresponding to a feed part of the second antenna A2′ and an area R2 corresponding to a feed part of the third antenna A3′. A stronger current may flow in the areas R1 and R2 than in other areas. This may be because the antennas operate as a current source rather than a voltage source. Due to the reciprocity between transmission and reception of the antennas, the path of a current flowing for radiation of the antennas may be the same as the path of a noise current induced in the antennas.

According to various embodiments of the disclosure, an antenna including a decoupling path of noise and an electronic device including the same may be provided. The decoupling path may be disposed at or around a feed part of an antenna where a noise current flow is strongest and thus may reduce noise induced in the antenna or an RF receiver. In addition, noise between antennas disposed close to each other may be reduced without an unnecessary waste of cost and space of the electronic device 10 having a limited volume.

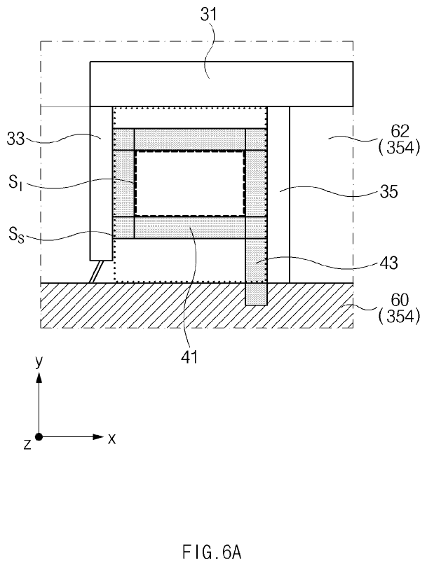

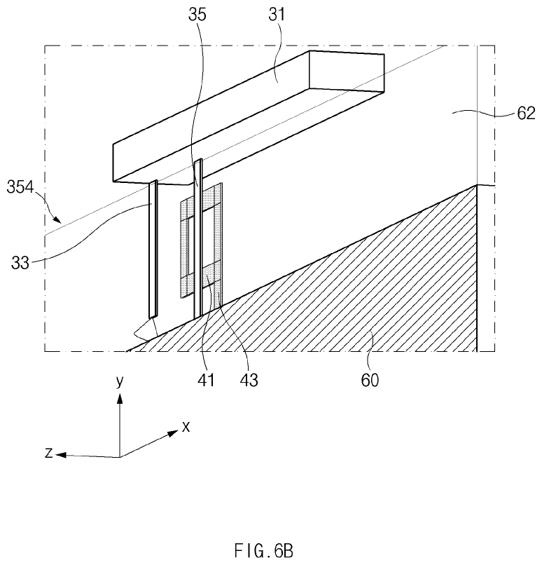

FIG. 6A is a view illustrating an antenna structure according to an embodiment. FIG. 6B is a view illustrating the antenna structure according to an embodiment. In FIGS. 6A and 6B, a planar inverted F antenna (PIFA) type antenna structure is illustrated. However, this is for convenience of description, and the antenna structure is not necessarily limited to having the PIFA type. For example, the antenna structure may include various antenna structures such as an IFA antenna, a monopole antenna, and a loop type antenna.

Referring to FIGS. 6A and 6B, the antenna structure 600 according to an embodiment may include a radiating arm 31, a feed line 33, a shorting line 35, and a decoupling pattern 41. In an embodiment, the antenna structure 600 may include the first antenna A1, the second antenna A2, or the third antenna A3 described with reference to FIG. 4B.

In an embodiment, the radiating arm 31 may include the conductive portion of the first housing structure 210 or the second housing structure 220 described with reference to FIGS. 4A and 4B. For example, the radiating arm 31 may at least partially include the first portion 21 of the second housing structure 220. For example, the radiating arm 31 may at least partially include the second portion 22 of the second housing structure 220. For example, the radiating arm 31 may at least partially include the third portion 23 of the second housing structure 220. In an embodiment, the radiating arm 31 may include a conductive pattern formed on the second substrate 354, a conductive pattern formed on a separate substrate distinguished from the second substrate 354, or a conductive pattern (e.g., a laser direct structuring (LDS) antenna) formed on an antenna carrier. The antenna carrier may include, for example, a bracket or cover that at least partially covers the second substrate 354, but is not limited thereto.

In an embodiment, the feed line 33 may be directly electrically connected to a first point of the radiating arm 31. The feed line 33 may electrically connect, directly or indirectly, the first point of the radiating arm 31 to the first wireless communication circuit disposed on the second substrate 354. The first wireless communication circuit may supply power to the radiating arm 31 through the feed line 33. In an embodiment, the feed line 33 may at least partially include a component that electrically connects, directly or indirectly, the conductive portion of the second housing structure 220 described with reference to FIGS. 4A and 4B to the first wireless communication circuit. For example, when the radiating arm 31 includes the third portion 23 of the second housing structure 220, the feed line 33 may at least partially include a conductive trace provided by the third connecting member 53 and the second substrate 354. The conductive trace of the second substrate 354 included in the feed line 33 may be referred to as a first conductive pattern.

In an embodiment, the shorting line 35 may electrically connect, directly or indirectly, a second point of the radiating arm 31 to a conductive area 60 of the second substrate 354. The conductive area 60 of the second substrate 354 may provide a ground of the antenna structure 600. Additionally, the conductive area 60 may provide a ground for various electrical/electronic components of the electronic device. The conductive area 60 may be referred to as a ground area 60. The second point of the radiating arm 31 may be a point different from the first point. For example, the first point may be closer to an end portion of the radiating arm 31 that faces in one direction than the second point. In an embodiment, the shorting line 35 may be at least partially formed in the layer in which the feed line 33 is disposed, among the layers of the second substrate 354. In an embodiment, the shorting line 35 may be at least partially formed by a conductive trace provided by the second substrate 354 and/or a connecting member (e.g., a contact member (e.g., a C-clip or a side-clip), a connector, or a coaxial cable formed of a conductive material) electrically connected to the second substrate 354. The conductive trace of the second substrate 354 included in the shorting line 35 may be referred to as a third conductive pattern.

In an embodiment, the second substrate 354 may include the decoupling pattern 41 and a pattern 43 electrically connecting the decoupling pattern 41 to the conductive area 60. The decoupling pattern 41 and the pattern 43 may include a conductive pattern formed on the second substrate 354. The conductive pattern may be formed of, for example, an electrically conductive material such as copper. In an embodiment, the decoupling pattern 41 may be disposed adjacent to the feed line 33. The decoupling pattern 41 may be electro-magnetically coupled with the feed line 33. In an embodiment, the decoupling pattern 41 may have a closed loop shape. The decoupling pattern 41 may be referred to as a second conductive pattern of the second substrate 354, and the second conductive pattern may be understood as including a closed loop shape.

In an embodiment, the decoupling pattern 41 and the pattern 43 may be formed in a first layer among the layers of the second substrate 354. In an embodiment, the feed line 33 and the shorting line 35 may be formed in a second layer among the layers of the second substrate 354. At least one layer may be interposed between the first layer and the second layer. For example, the second substrate 354 may be constituted by ten layers. The first layer in which the decoupling pattern 41 and the pattern 43 are formed may be the lowermost layer among the ten layers. The second layer in which the feed line 33 and the shorting line 35 are formed may be the uppermost layer among the ten layers. However, the disclosure is not limited by the above-described example.

In an embodiment, the decoupling pattern 41 may be at least partially located between the feed line 33 and the shorting line 35. For example, when the second substrate 354 is viewed from above (e.g., in the z-axis direction), the outer boundary of the decoupling pattern 41 may be located between the feed line 33 and the shorting line 35, and the decoupling pattern 41 may not overlap the feed line 33 and the shorting line 35. For example, when the second substrate 354 is viewed from above, the outer boundary of the decoupling pattern 41 may overlap the feed line 33 and/or the shorting line 35, and the inner boundary of the decoupling pattern 41 may be located between the feed line 33 and the shorting line 35.

In an embodiment, the decoupling pattern 41 may be located between the radiating arm 31 and the conductive area 60. For example, when the second substrate 354 is viewed from above (e.g., in the z-axis direction), the decoupling pattern 41 may be located between the radiating arm 31 and the conductive area 60. A non-conductive area 62 of the second substrate 354 may be at least partially disposed between the radiating arm 31 and the conductive area 60. For example, when the second substrate 354 is viewed from above (e.g., in the z-axis direction), the non-conductive area 62 may be at least partially formed between the radiating arm 31 and the conductive area 60. When the second substrate 354 is viewed from above (e.g., in the z-axis direction), the decoupling pattern 41 may at least partially overlap the non-conductive area 62. When the second substrate 354 is viewed from above (e.g., in the z-axis direction), the conductive pattern of the second substrate 354 that at least partially constitutes the feed line 33 may at least partially overlap the non-conductive area 62. When the second substrate 354 is viewed from above (e.g., in the z-axis direction), the conductive pattern of the second substrate 354 that at least partially constitutes the shorting line 35 may at least partially overlap the non-conductive area 62.

In an embodiment, at least a portion of the decoupling pattern 41 may be disposed in a layer of the second substrate 354 that is different from the layer in which the feed line 33 and/or the shorting line 35 are disposed. For example, at least a portion of the decoupling pattern 41 may be disposed in the first layer of the second substrate 354, and at least a portion of the feed line 33 may be disposed in the second layer of the second substrate 354 that is different from the first layer. For example, a first portion of the decoupling pattern 41 may be disposed in the first layer, and a second portion of the decoupling pattern 41 may be disposed in the second layer in which the feed line 33 is disposed. In this case, the first portion and the second portion of the decoupling pattern 41 may be electrically connected with each other through a conductive VIA that vertically penetrates the layers of the second substrate 354. For example, the entire decoupling pattern 41 may be disposed in a layer different from the layer in which the feed line 33 is disposed. In an embodiment, the decoupling pattern 41 may be disposed in the same layer as the feed line 33 and/or the shorting line 35.

In an embodiment, a passive element, such as an inductor or a capacitor, may be interposed in the feed line 33 and/or the shorting line 35. Because the passive element is disposed on a surface of the second substrate 354, at least a portion of the feed line 33 and/or the shorting line 35 connected with the passive element may be formed on the surface of the second substrate 354. When the decoupling pattern 41 is formed on the surface of the second substrate 354, the decoupling pattern 41 may be disposed in the same layer as at least a portion of the feed line 33 and/or the shorting line 35. However, the disclosure is not limited by the above-described example, and the passive element may not be interposed in the feed line 33 and the shorting line 35.

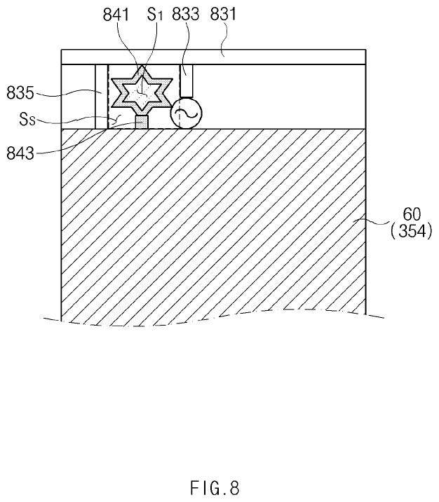

In an embodiment, the feed line 33 and the shorting line 35 may be spaced apart from each other. In addition, the radiating arm 31 and the conductive area 60 of the second substrate 354 may be spaced apart from each other. A first loop area S_{S} may be defined by the feed line 33, the shorting line 35, the radiating arm 31, and the conductive area 60 of the second substrate 354 spaced apart from each other. In an embodiment, a second loop area S₁ may be defined by the closed loop of the decoupling pattern 41. The first loop area S_{S} and the second loop area S₁ are illustrated as having a quadrangular shape, but are not limited thereto. For example, the second loop area S₁ may include a circular shape or an oval shape or, as illustrated in FIG. 8, may include a polygonal shape rather than a quadrangular shape.

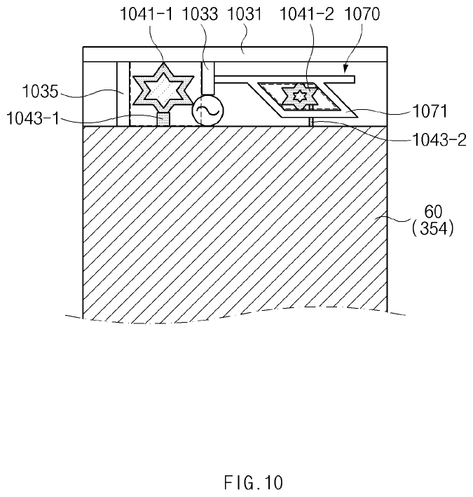

Although one first loop area S_{S} is illustrated in FIGS. 6A and 6B, the disclosure is not limited thereto. As described above with reference to the conductive structure of the second housing structure 220, the feed line 33 and/or the shorting line 35 of the radiating arm 31 may be provided in plural depending on the required wireless communication performance of the antenna. Accordingly, the first loop area S_{S} may be provided in plural. For example, the first loop area S_{S} may further include at least one of a loop area formed by a plurality of feed lines 33, a loop area formed by the feed line 33 and the shorting line 35, or a loop area formed by a plurality of shorting lines 35. For example, the first loop area S_{S} may further include a loop area defined by a separate conductive pattern (e.g., an antenna pattern 1070 of FIG. 10) provided by the second substrate 354. Although one decoupling pattern 41 and one second loop area S₁ defined by the one decoupling pattern 41 are illustrated in FIGS. 6A and 6B, the disclosure is not limited thereto. For example, the decoupling pattern 41 may further include a decoupling pattern corresponding to at least one of the plurality of first loop areas S_{S}, and accordingly a plurality of second loop areas S₁ may be defined.

In an embodiment, the area of the second loop area S₁ may be smaller than the area of the first loop area S_{S}, but is not limited thereto. However, when the area of the second loop area S₁ is greater than or equal to the area of the first loop area S_{S}, the radiation performance of the antenna structure 600 may be affected.

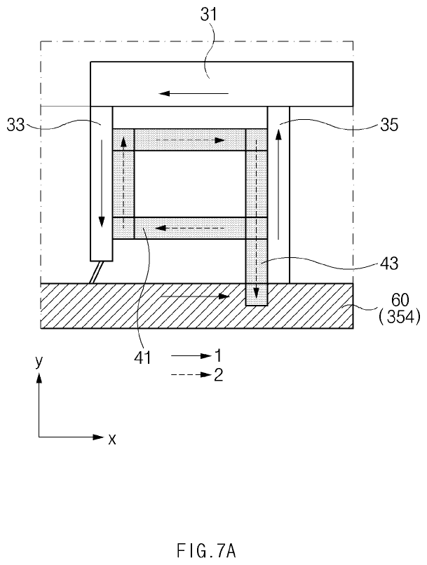

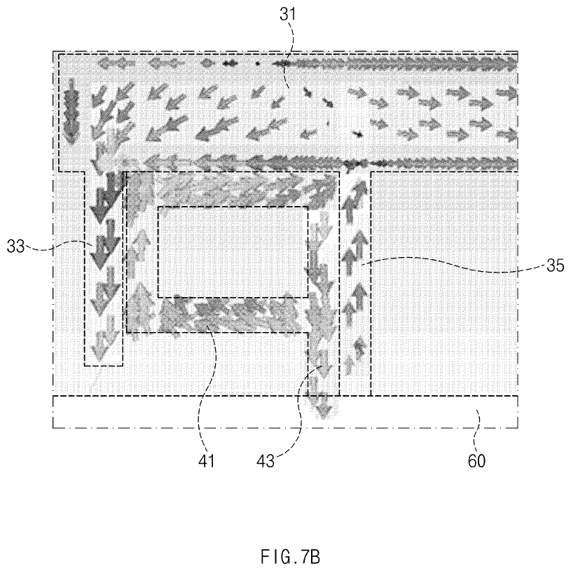

FIG. 7A is a view illustrating a noise current flow of the antenna structure according to an embodiment. FIG. 7B is a view illustrating the noise current flow and intensity of the antenna structure according to an embodiment. In FIG. 7B, the end of each arrow indicates the flow direction of the current, and the intensity of shading of the arrow indicates the strength of the current.

Referring to FIGS. 7A and 7B, for example, when a noise current flows in the antenna structure 600, a noise current 1 of a first path may flow in the radiating arm 31, the feed line 33, and the shorting line 35. The decoupling pattern 41 may form a parasitic structure for the radiating arm 31, the feed line 33, and the shorting line 35. A differential mode current 2 against the noise current 1 of the first path may be induced in the decoupling pattern 41 by an image theorem. The current 2 of the decoupling pattern 41 may be transferred to the conductive area 60 of the second substrate 354 through the pattern 43. The decoupling pattern 41 may provide an electrical path for transferring noise induced in the antenna structure 600 to the conductive area 60 of the second substrate 354. Accordingly, the noise induced in the antenna structure 600 may be prevented or reduced from being transferred to a victim (e.g., an RF receiver connected to the feed line 33). For example, the decoupling pattern 41 may provide noise shielding for the victim. In addition, referring to FIG. 7B, because the noise current most strongly flows in the feed line 33 of the antenna structure 600, the noise shielding effect due to the decoupling pattern 41 adjacent to the feed line 33 may be improved.

In an embodiment, the noise current induced in the decoupling pattern 41 may be dominated by the differential mode current 2, but may include a common mode current. The common mode current may improve the resonance characteristics (e.g., the radiation efficiency and the bandwidth) of the radiating arm 31.

FIG. 8 is a view illustrating an antenna structure according to an embodiment.

Referring to FIG. 8, the antenna structure 800 according to an embodiment may include a radiating arm 831, a feed line 833, a shorting line 835, a decoupling pattern 841, and a pattern 843. In an embodiment, the descriptions of the antenna structure 600, the radiating arm 31, the feed line 33, the shorting line 35, the decoupling pattern 41, and the pattern 43, which have been provided with reference to FIG. 6A, may be applied to the antenna structure 800, the radiating arm 831, the feed line 833, the shorting line 835, the decoupling pattern 841, and the pattern 843 in a substantially identical, similar, or corresponding manner. Repetitive descriptions will hereinafter be omitted.

In an embodiment, the decoupling pattern 841 may have a polygonal shape rather than a quadrangular shape. In an embodiment, the feed line 833 and the shorting line 835 that define a first loop area S_{S} may be located opposite to those illustrated in FIG. 6A. For example, a first point of the radiating arm 831 to which the feed line 833 is connected may be closer to an end portion of the radiating arm 831 that faces in one direction than a second point of the radiating arm 831 to which the shorting line 835 is connected.

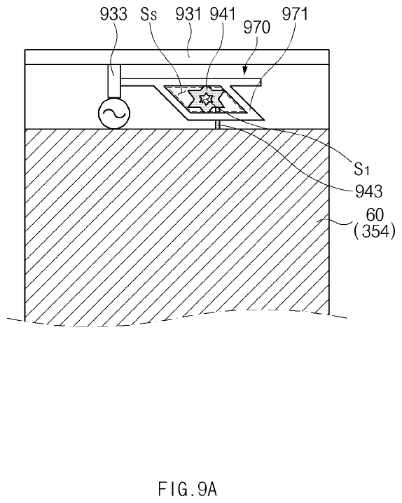

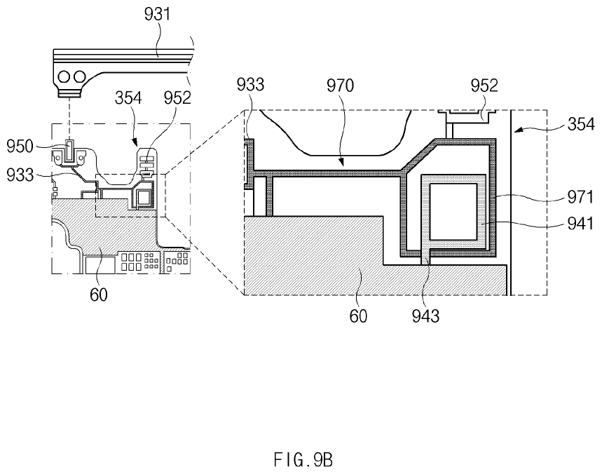

FIG. 9A is a view illustrating an antenna structure according to an embodiment. FIG. 9B is a view illustrating the antenna structure according to an embodiment.

Referring to FIGS. 9A and 9B, the antenna structure 900 according to an embodiment may include a radiating arm 931, a feed line 933, a decoupling pattern 941, and a pattern 943. In an embodiment, the descriptions of the antenna structure 600, the radiating arm 31, the feed line 33, the decoupling pattern 41, and the pattern 43, which have been provided with reference to FIG. 6A, may be applied to the antenna structure 900, the radiating arm 931, the feed line 933, the decoupling pattern 941, and the pattern 943 in a substantially identical, similar, or corresponding manner. Repetitive descriptions will hereinafter be omitted.

In an embodiment, the antenna structure 900 may include a first connecting member 950, a second connecting member 952, and an antenna pattern 970.

In an embodiment, the first connecting member 950 may include the first connecting member 51, the second connecting member 52, the third connecting member 53, or the fourth connecting member 54 illustrated in FIG. 4B. The first connecting member 950 may be electrically connected between the radiating arm 931 and the feed line 933. The first connecting member 950 may be understood as being included in the feed line 933 in that the radiating arm 931 is electrically connected with the first wireless communication circuit on the second substrate 354 through the first connecting member 950 and receives power through the first connecting member 950.

In an embodiment, the antenna pattern 970 may include a conductive pattern formed on the second substrate 354. The conductive pattern may include an electrically conductive material (e.g., copper).

In an embodiment, the antenna pattern 970 may diverge from the feed line 933. For example, a conductive trace (e.g., the first conductive pattern) of the second substrate 354 included in the feed line 933 may extend from a first point of the conductive area 60 of the second substrate 354 to a second point of the first connecting member 950 disposed on the second substrate 354, and the antenna pattern 970 may extend from a point of the feed line 933 between the first point and the second point. The antenna pattern 970 may be referred to as a fourth conductive pattern of the second substrate 354.

In an embodiment, at least one passive element, such as an inductor or a capacitor, may be interposed in the antenna pattern 970. The antenna pattern 970, together with the radiating arm 931, may operate as a radiating element of the antenna structure 900. By the antenna pattern 970, the antenna structure 900 may form a multi-band resonant frequency, and the bandwidth of the resonant frequency may be improved.

In an embodiment, the antenna pattern 970 may include a loop pattern 971. The loop pattern 971 may include a closed loop shape, but is not limited thereto. The loop pattern 971 may include a polygonal shape, but is not limited thereto. The loop pattern 971 of the antenna pattern 970 may define a first loop area therein. In an embodiment, the decoupling pattern 941 may be at least partially located within the loop pattern 971 of the antenna pattern 970. The decoupling pattern 941 may define a second loop area therein. The description provided with reference to the first loop area S_{S} and the second loop area S₁ may be applied to the first loop area of the antenna pattern 970 and the second loop area of the decoupling pattern 941 in a substantially identical, similar, or corresponding manner.

In an embodiment, the second connecting member 952 may be electrically connected to the antenna pattern 970. For example, the second connecting member 952 may be electrically connected to the loop pattern 971 of the antenna pattern 970. An additional antenna radiator (not illustrated) or a dummy pattern may be electrically connected to the second connecting member 952. However, the disclosure is not limited thereto. For example, the antenna structure 900 may not include the second connecting member 952.

In FIG. 9B, the radiating arm 931 is illustrated as having the same shape as a conductive portion (e.g., the third portion 23) of the second housing structure 220, but is not limited thereto. The radiating arm 931 may include, for example, a conductive member or structure of the electronic device 10 distinguished from a conductive pattern formed on the second substrate 354 or the conductive portion of the second housing structure 220.

FIG. 10 is a view illustrating an antenna structure according to an embodiment. Referring to FIG. 10, the antenna structure 1000 according to an embodiment may include a structure in which the antenna structure 800 of FIG. 8 and the antenna structure 900 of FIG. 9A are coupled. For example, the antenna structure 1000 may include a first structure corresponding to the antenna structure 800 and a second structure corresponding to the antenna structure 900. The first structure may include a radiating arm 1031, a feed line 1033, a shorting line 1035, a decoupling pattern 1041-1, and a pattern 1043-1 that correspond to the radiating arm 831, the feed line 833, the shorting line 835, the decoupling pattern 841, and the pattern 843 of the antenna structure 800, respectively. The second structure may include a radiating arm 1031, a feed line 1033, an antenna pattern 1070, a loop pattern 1071, a decoupling pattern 1041-2, and a pattern 1043-2 that correspond to the radiating arm 931, the feed line 933, the antenna pattern 970, the loop pattern 971, the decoupling pattern 941, and the pattern 943 of the antenna structure 900, respectively.

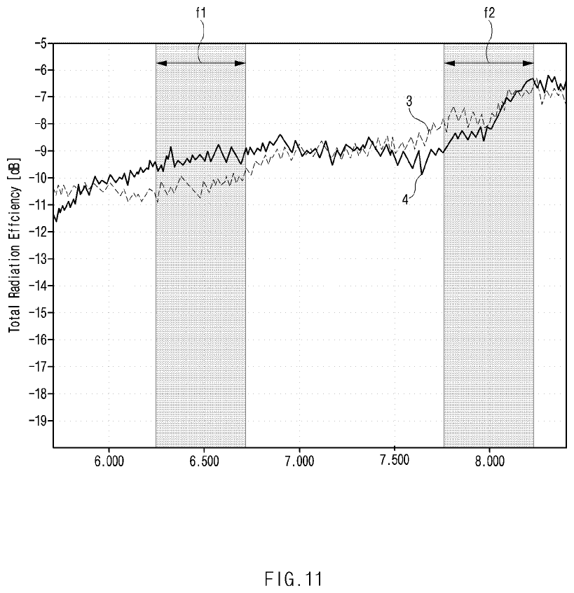

FIG. 11 is a graph depicting radiation efficiencies of antennas. In FIG. 11, graph 3 represents the radiation efficiency of the electronic device 10 including an antenna structure according to an embodiment, and graph 4 represents the radiation efficiency of an electronic device according to a comparative example. The electronic device according to the comparative example may not include a decoupling pattern of an antenna structure (e.g., the decoupling pattern 41 of FIG. 6A).

Referring to FIG. 11, the radiation efficiencies of graph 3 and graph 4 in a first frequency band f1 (e.g. UWB channel 9 having a center frequency of about 6.5 GHz) may be similar to each other. In a second frequency band f2 (e.g. UWB channel 9 having a center frequency of about 8 GHZ), the radiation efficiency of graph 3 may be partially improved when compared to the radiation efficiency of graph 4.

Table 1 below shows the receive sensitivity for the second frequency band f2.

TABLE 1

| | Second frequency band f2 | |
|---|---|---|
| | Vertical polarization | Horizontal polarization |
| Classification | [−dBm] | [−dBm] |
| First example | 87.2 | 85.1 |
| Second example | 83.2 | 80.6 |
| Third example | 87.7 | 85.1 |

The first example represents the receive sensitivity in a situation in which a noise source does not exist, for example, in a situation in which an antenna capable of acting as a noise source does not operate. The second example represents the receive sensitivity of the electronic device according to the comparative example. In the second example, the electronic device according to the comparative example may not include a decoupling pattern of an antenna structure (e.g., the decoupling pattern 41 of FIG. 6A). The third example represents the receive sensitivity of the electronic device 10 including an antenna structure according to an embodiment. Referring to Table 1 above, due to noise, the receive sensitivity in the second example may be lower than the receive sensitivity in the first example. The receive sensitivity in the third example may be improved when compared to the receive sensitivity for the vertical polarization in the first example and may be equal to the receive sensitivity for the horizontal polarization in the first example. In addition, the receive sensitivity in the third example may be improved when compared to the receive sensitivity in the second example.

An electronic device according to an embodiment (e.g., the electronic device 10 of FIG. 1) may include a substrate (e.g., the second substrate 354 of FIG. 3B) and a wireless communication circuit (e.g., the wireless communication module 1292 of FIG. 12, comprising communication circuitry). The substrate may include a housing (e.g., the housing 200 of FIG. 1), a ground area (e.g., the conductive area 60 of FIG. 6A), a first conductive pattern (e.g., the feed line 33 of FIG. 6A), a second conductive pattern (e.g., the decoupling pattern 41 of FIG. 6A), and a third conductive pattern (e.g., the shorting line 35 of FIG. 6A). The housing may include a conductive portion (e.g., the third portion 23 of FIG. 4B). The first conductive pattern may be electrically connected to the conductive portion. The second conductive pattern may be electrically connected to the ground area. The first conductive pattern may electrically connect the conductive portion to the ground area. The wireless communication circuit may be configured to supply power to the conductive portion through the first conductive pattern. The second conductive pattern may include a closed loop shape. The second conductive pattern may be at least partially located between the first conductive pattern and the third conductive pattern.

In an embodiment, the second conductive pattern may not overlap the first conductive pattern and the third conductive pattern when the substrate is viewed from above.

In an embodiment, the substrate may include a first layer and a second layer different from the first layer. The first conductive pattern may be disposed in the first layer. The second conductive pattern may be disposed in the second layer.

In an embodiment, the substrate may include a plurality of layers including the first layer and the second layer. The first layer may be located in the uppermost layer among the plurality of layers. The second layer may be located in the lowermost layer among the plurality of layers.

In an embodiment, the electronic device may include a first loop area (e.g., the first loop area S_{S} of FIG. 6A) and a second loop area (e.g., the second loop area S₁ of FIG. 6A). The first loop area may be defined by the conductive portion, the ground area, the first conductive pattern, and the third conductive pattern. The second loop area may be defined by the closed loop shape of the second conductive pattern.

In an embodiment, the second loop area may have a smaller area than the first loop area.

In an embodiment, the electronic device may include a first loop area (e.g., the first loop area S_{S} of FIG. 6A) and a second loop area (e.g., the second loop area S₁ of FIG. 6A). The first loop area may be defined by the conductive portion, the ground area, the first conductive pattern, and the third conductive pattern. The second loop area may be defined by the closed loop shape of the second conductive pattern. A differential mode current may flow in the first loop area and the second loop area.

In an embodiment, the conductive portion may include a first portion (e.g., the third portion 23 of FIG. 4B) and a second portion (e.g., the first portion 21 or the second portion 22 of FIG. 4B). The second portion may be spaced apart from the first portion and may be electrically connected, directly or indirectly, to the wireless communication circuit. The first conductive pattern and the third conductive pattern may be electrically connected, directly or indirectly, to the first portion. The wireless communication circuit may be configured to transmit and receive a wireless signal using the first portion and the second portion.

In an embodiment, the first conductive pattern may be electrically connected, directly or indirectly, to a first point of the first portion. The third conductive pattern may be electrically connected, directly or indirectly, to a second point of the first portion. The first point may be closer to an end of the first portion than the second point.

In an embodiment, the substrate may further include a pattern (e.g., the pattern 43 of FIG. 6A) that electrically connects, directly or indirectly, the second conductive pattern to the ground area.

In an embodiment, the electronic device may include a connecting member (e.g., the second connecting 52 of FIG. 4B) disposed on the substrate. The connecting member may electrically connect, directly or indirectly, the first conductive pattern to the conductive portion.

In an embodiment, the electronic device may include at least one passive element interposed in at least one of the first conductive pattern, the second conductive pattern, or the third conductive pattern.

An electronic device according to an embodiment (e.g., the electronic device 10 of FIG. 1) may include a housing (e.g., the housing 200 of FIG. 1), a substrate (e.g., the second substrate 354 of FIG. 3B) and a wireless communication circuit (e.g., the wireless communication module 1292 of FIG. 12). The housing may include a conductive portion (e.g., the third portion 23 of FIG. 4B). The substrate may include a ground area (e.g., the conductive area 60 of FIG. 9A or 10), a first conductive pattern (e.g., the feed line 933 of FIG. 9A or the feed line 1033 of FIG. 10), a second conductive pattern (e.g., the decoupling pattern 941 of FIG. 9A or the decoupling pattern 1041-2 of FIG. 10), and a fourth conductive pattern (e.g., the antenna pattern 970 of FIG. 9A or the antenna pattern 1070 of FIG. 10). The first conductive pattern may be electrically connected, directly or indirectly, to the conductive portion. The second conductive pattern may be electrically connected, directly or indirectly, to the ground area. The fourth conductive pattern may diverge and extend from the first conductive pattern. The wireless communication circuit may be configured to supply power to the conductive portion through the first conductive pattern. The second conductive pattern may include a closed loop shape. The fourth conductive pattern may include a loop pattern (e.g., the loop pattern 971 of FIG. 9A or the loop pattern 1071 of FIG. 9A). The second conductive pattern may be at least partially located within the loop pattern of the fourth conductive pattern.

In an embodiment, the substrate may include a third conductive pattern (e.g., the shorting line 1035 of FIG. 10) and a fifth conductive pattern (e.g., the decoupling pattern 1041-1 of FIG. 10). The third conductive pattern may electrically connect the conductive portion to the ground area. The fifth conductive pattern may be electrically connected to the ground area. The fifth conductive pattern may include a closed loop shape. The fifth conductive pattern may be at least partially located between the first conductive pattern and the third conductive pattern.

In an embodiment, an area defined by the closed loop shape of the second conductive pattern may be smaller than an area defined by the loop pattern of the fourth conductive pattern.

In an embodiment, the electronic device may include a first loop area defined by the conductive portion, the ground area, the first conductive pattern, and the third conductive pattern and a second loop area defined by the closed loop shape of the second conductive pattern. The second loop area may have a smaller area than the first loop area.

In an embodiment, the second conductive pattern may not overlap the loop pattern when the substrate is viewed from above.

In an embodiment, the electronic device may include a first loop area defined by the loop pattern and a second loop area defined by the closed loop shape of the second conductive pattern. The second loop area may have a smaller area than the first loop area.

In an embodiment, the electronic device may include a first loop area defined by the loop pattern and a second loop area defined by the closed loop shape of the second conductive pattern. A differential mode current may flow in the first loop area and the second loop area.

An electronic device according to an embodiment (e.g., the electronic device 10 of FIG. 1) may include an antenna structure (e.g., the antenna structure 600 of FIG. 6A), a substrate (e.g., the second substrate 354 of FIG. 6A), and a wireless communication circuit (e.g., the wireless communication module 1292 of FIG. 12) disposed on the substrate. The antenna structure may include a radiating arm (e.g., the radiating arm 31 of FIG. 6A), a feed line (e.g., the feed line 33 of FIG. 6A), a shorting line (e.g., the shorting line 35 of FIG. 6A), and a decoupling pattern (e.g., the decoupling pattern 41 of FIG. 6A). The feed line may at least partially include a conductive pattern of the substrate and may be electrically connected between the wireless communication circuit and the radiating arm. The shorting line may at least partially include a conductive pattern of the substrate and may ground the radiating arm. The decoupling pattern may include a conductive pattern of the substrate. The decoupling pattern may include a closed loop shape. The decoupling pattern may be at least partially located between the feed line and the shorting line.

In an embodiment, the electronic device may include a housing (e.g., the housing 200 of FIG. 1) including a conductive portion (e.g., the third portion 23 of FIG. 4B), and the radiating arm may include the conductive portion or a conductive pattern of the substrate.

FIG. 12 is a block diagram illustrating an electronic device 1201 in a network environment 1200 according to various embodiments. Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In some embodiments, at least one of the components (e.g., the connecting terminal 1278) may be omitted from the electronic device 1201, or one or more other components may be added in the electronic device 1201. In some embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to one embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290 comprising communication circuitry) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thererto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 1264 dB or less) for implementing mMTC, or U-plane latency (e.g., 0.5 ms or less for each of downlink (DL) and uplink (UL), or a round trip of 12 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a housing including a conductive portion;
a substrate including a ground area, a first conductive pattern electrically connected to the conductive portion, a second conductive pattern electrically connected to the ground area, and a third conductive pattern configured to electrically connect the conductive portion to the ground area; and
a wireless communication circuit configured to supply power to the conductive portion through at least the first conductive pattern,
wherein the second conductive pattern includes a closed loop shape and is at least partially located between at least the first conductive pattern and the third conductive pattern.

2. The electronic device of claim 1, wherein the second conductive pattern does not overlap the first conductive pattern and the third conductive pattern, when the substrate is viewed from above.

3. The electronic device of claim 1, wherein the substrate includes a first layer and a second layer different from the first layer,
wherein the first conductive pattern is disposed in the first layer, and
wherein the second conductive pattern is disposed in the second layer.

4. The electronic device of claim 3, wherein the substrate includes a plurality of layers including the first layer and the second layer,
wherein the first layer is located in the uppermost layer among the plurality of layers, and
wherein the second layer is located in the lowermost layer among the plurality of layers.

5. The electronic device of claim 1, wherein the electronic device comprises a first loop area defined by the conductive portion, the ground area, the first conductive pattern, and the third conductive pattern and a second loop area defined by the closed loop shape of the second conductive pattern, and
wherein the second loop area has a smaller area than the first loop area.

6. The electronic device of claim 1, wherein the electronic device comprises a first loop area defined by the conductive portion, the ground area, the first conductive pattern, and the third conductive pattern and a second loop area defined by the closed loop shape of the second conductive pattern, and
Wherein the first loop area is configured for a differential mode current to flow in the first loop area and the second loop area.

7. The electronic device of claim 1, wherein the conductive portion includes a first portion and second portions spaced apart from the first portion and electrically connected to the wireless communication circuit,
wherein the first conductive pattern and the third conductive pattern are electrically connected to the first portion, and
wherein the wireless communication circuit is configured to transmit and receive a wireless signal using the first portion and the second portions.

8. The electronic device of claim 7, wherein the first conductive pattern is electrically connected to a first point of the first portion,
wherein the third conductive pattern is electrically connected to a second point of the first portion, and
wherein the first point is closer to an end of the first portion than the second point.

9. The electronic device of claim 1, wherein the substrate further includes a pattern configured to electrically connect the second conductive pattern to the ground area.

10. The electronic device of claim 1, further comprising:
a connecting member, comprising conductive material, disposed on the substrate,
wherein the connecting member electrically connects the first conductive pattern to the conductive portion.

11. The electronic device of claim 1, further comprising:
at least one passive element, comprising a capacitor and/or inductor, interposed in at least one of: the first conductive pattern, the second conductive pattern, or the third conductive pattern.

12. An electronic device comprising:
a housing including a conductive portion;
a substrate including a ground area, a first conductive pattern electrically connected to the conductive portion, a second conductive pattern electrically connected to the ground area, and another conductive pattern configured to diverge and extend from the first conductive pattern; and
a wireless communication circuit configured to supply power to the conductive portion through the first conductive pattern,
wherein the second conductive pattern includes a closed loop shape,
wherein the another conductive pattern includes a loop pattern, and
wherein the second conductive pattern is at least partially located within the loop pattern of the another conductive pattern.

13. The electronic device of claim 12, wherein the substrate further includes a third conductive pattern configured to electrically connect the conductive portion to the ground area and a fifth conductive pattern electrically connected to the ground area, and
wherein the fifth conductive pattern includes a closed loop shape and is at least partially located between the first conductive pattern and the third conductive pattern.

14. The electronic device of claim 12, wherein an area defined by the closed loop shape of the second conductive pattern is smaller than area defined by the loop pattern of the another conductive pattern.

15. The electronic device of claim 13, wherein the electronic device comprises a first loop area defined by the conductive portion, the ground area, the first conductive pattern, and the third conductive pattern and a second loop area defined by the closed loop shape of the second conductive pattern, and
wherein the second loop area has a smaller area than the first loop area.

16. The electronic device of claim 12, wherein the second conductive pattern does not overlap the loop pattern when the substrate is viewed from above.

17. The electronic device of claim 12, wherein the electronic device comprises:
a first loop area defined by the loop pattern; and
a second loop area defined by the closed loop shape of the second conductive pattern, and
wherein the second loop area has a smaller area than the first loop area.

18. The electronic device of claim 12, wherein the electronic device comprises:
a first loop area defined by the loop pattern; and
a second loop area defined by the closed loop shape of the second conductive pattern, and
wherein the first loop area is configured for a differential mode current to flow in the first loop area and the second loop area.

19. An electronic device comprising:
an antenna structure;
a substrate; and
a wireless communication circuit disposed on the substrate,
wherein the antenna structure includes:
a radiating arm;
a feed line at least partially including a conductive pattern of the substrate, the feed line being electrically connected between at least the wireless communication circuit and the radiating arm;
a shorting line at least partially including a conductive pattern of the substrate, the shorting line being configured to ground the radiating arm; and
a decoupling pattern including a conductive pattern of the substrate, and
wherein the decoupling pattern includes a closed loop shape and is at least partially located between at least the feed line and the shorting line.

20. The electronic device of claim 19, further comprising:
a housing including a conductive portion,
where the radiating arm includes at least one of:
the conductive portion; or
a conductive pattern of the substrate.
